(19) United States
(12) Patent Application Publication
(10) Pub. No.: US 2002/0062981 A1
(43) Pub. Date: May 30, 2002

(54) Cable system with varied wires or fibres

(76) Inventors: Cornelis Antonius Agnes Maria Nuyten, Roosendaal (NL); Roy Nienhuis, Winterswijk (NL)

Correspondence Address: YOUNG & THOMPSON, 745 SOUTH 23RD STREET 2ND FLOOR, ARLINGTON, VA, 22202

(21) Appl. No.: 09/990,307

(22) Filed: Nov. 23, 2001

(30) Foreign Application Priority Data
Nov. 23, 2000 (NL) 1016692

(51) Int. Cl. H01B 7/08

(52) U.S. Cl. 174/117 F

(57) ABSTRACT

A cable system comprises a bundle of stacked flat layers, each of which comprises a series of electrical wires, at least one protective layer between two adjacent flat layers, and a common protective sheath. At least one of the layers comprises wires of different thicknesses. The wires of a relatively large thickness can be in a flat layer opposite wires of a relatively small thickness in a neighboring flat layer.

The invention relates to a cable system comprising a bundle of stacked flat layers, each of which comprises a series of electrical wires, at least one protective layer between two adjacent flat layers, and a common protective sheath.

Cable systems of this type are known. The layers (flat cables) thereof can contain wires or transmitting electrical signals. Individual flat cables are also known in which electrical wires are combined with optical fibres.

A cable system is usually employed to transmit a large number of different signals. The nature and the strength of these signals can vary substantially. For these reasons it is desirable to match the electrical wires in an optimum manner to the signals that have to be transmitted.

According to the invention this can be achieved in that at least one of the layers comprises wires of different thicknesses.

The wires can have a thickness such that the signal to be handled therewith can be transmitted in an optimum manner. The differences in thickness which arise as a consequence of these varied wires in the layers can be absorbed by the bundle without major problems. Optionally wires of a relatively large thickness can be located in one flat layer opposite wires of a relatively small thickness in a neighboring flat layer.

According to a her possible variant, at least one of the flat layers can comprise an optical fibre; in particular at least one of the flat layers can comprise at least one electrical wire and at least one optical fibre. Furthermore, twisted wires can also be incorporated in one or more flat layers.

The invention will be explained in more detail below with reference to a few illustrative embodiments shown in the figures.

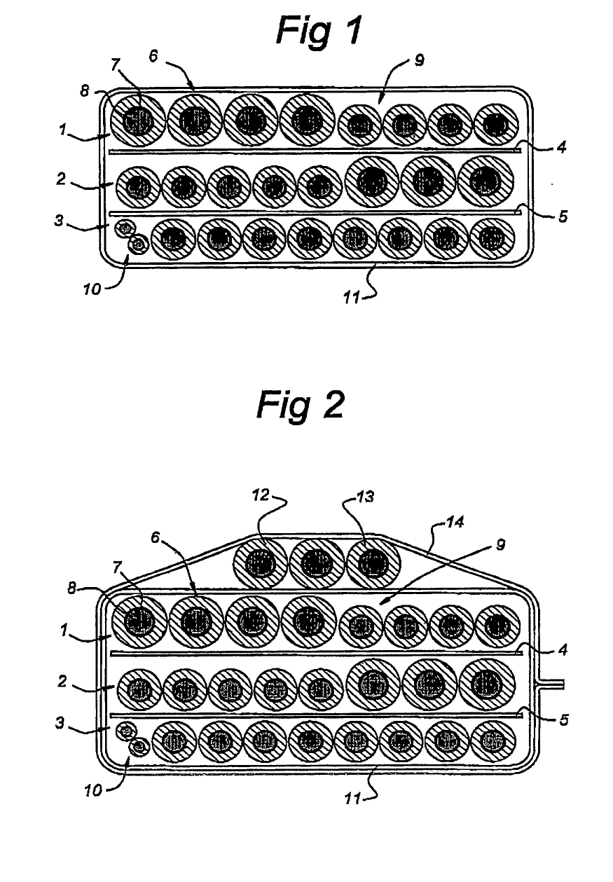

FIG. 1 shows a cross-section of the cable system according to the invention.

FIG. 2 shows an assembly containing the cable system according to FIG. 1.

FIG. 1 shows a cable system containing a bundle of flat cables or flat layers 1, 2, 3 separated from one another by protective layers 4, 5. Each flat layer 1, 2, 3 consists of a coherent series of electrical wires 6, 9, each having an insulation layer 7 and an electrical conductor 8.

For the purposes of efficient signal transmission, some electrical wires 9 are thinner than the other electrical wires 6. The differences in thickness in the different layers 1, 2 are compensated for by positioning the thicker wires 6 from layer 1 opposite the thinner wires 9 in laser 2, and vice versa.

Furthermore, a twisted wire pair 10 can also be incorporated; see the flat layer 3.

The variant shown in FIG. 2 relates to a cable system as shown in FIG. 1, to which electrical wires 12 and an optical fibre 13 outside the protective sheath 11 have been added. These fibres are attached to the cable system by means of binding cords/binding bands 14 which are arranged uniform distances apart over the length of the cable system. The fibres can also be attached by tape.

1. Cable system comprising a bundle of stacked flat layers (1-3), each of which composes a series of electrical wires (6, 9, 10), at least one protective layer (4, 5) between two adjacent flat layers (1-3), and a common protective sheath (11), characterized in that at least one of the layers (1, 2) comprises wires (6, 9) of different thicknesses.

2. Cable system according to claim 1, wherein at least one of the flat layers comprises an optical fibre.

3. Cable system according to claim 2, wherein at least one of the flat layers comprises at lease one electrical wire and at least one optical fibre.

4. Cable system according to claim 1, 2 or 3, wherein at least one of the flat layers (3) comprises at least one pair (10) of twisted wires.

5. Cable system according to one of the preceding claims, wherein a protective layer (4, 5) is present between at least two flat layers (1-3).

6. Cable system according to one of the preceding claims, wherein wires (6) of a relatively large thickness are present in a flat layer (1, 2) opposite wires (9) of a relatively small thickness in a neighboring flat layer (1, 2).

7. Assembly, comprising a cable system according to one of the preceding claims, as well as an electrical wire (12) and/or an optical fibre (13) which are located outside the protective sheath (11) and are attached thereto by fastening means (14).
